(19) United States
(12) Patent Application Publication
(10) Pub. No.: US 2009/0001232 A1
(43) Pub. Date: Jan. 1, 2009

(54) MOBILE DEVICE

(76) Inventors: Dong-Min Seo, Okcheon-gun (KR); Weon-Heang Choi, Seoul-si (KR)

Correspondence Address: BIRCH STEWART KOLASCH & BIRCH, PO BOX 747, FALLS CHURCH, VA, 22040-0747, US

(21) Appl. No.: 12/147,345

(22) Filed: Jun. 26, 2008

(30) Foreign Application Priority Data
Jun. 27, 2007 (KR) 10-2007-0063800
Aug. 7, 2007 (KR) 10-2007-0079229
Sep. 5, 2007 (KR) 10-2007-0090120
Oct. 10, 2007 (KR) 10-2007-0101852
Oct. 10, 2007 (KR) 10-2007-0101853

(51) Int. Cl. F16M 11/00; A47G 29/00; E05D 5/10

(52) U.S. Cl. 248/176.1; 248/694; 16/386; 248/317

(57) ABSTRACT

The present invention relates to a mobile device. In the present invention, a speaker is installed to a seating portion formed on a rear surface of a main body. The speaker is rotatably installed to the main body, so that the main body can be selectively stably supported on the ground. Also, an insertion portion is concavely formed in one surface of the main body, and a support plate is inserted into the insertion portion to support the main body on the ground. In addition, a hanger is coupled to an outside of the main body so that the main body is caught to an external article. According to the present invention, a better design for an external appearance is provided to the mobile device and convenience of a user is enhanced since the mobile device can stand by the speaker or the support plate. In addition, the main body can be caught to a collar of a user or a hook, whereby the user can easily carry the mobile device.

### BACKGROUND OF THE INVENTION

1. Field of the Invention

The present invention relates to a mobile device, and more particularly, to a mobile device that converts an electric signal into a voice signal.

2. Description of the Related Art

Along with the development of multimedia technology, the demand on devices for playing back multimedia content is recently increased. Also, in order to easily utilize and appreciate various contents, there are recently proposed various portable devices capable of storing various kinds of multimedia data such that users may play back and utilize such multimedia data anytime at any place.

One of such devices is a portable multimedia player (PMP), which makes it possible to play back moving picture data such as AVI and MPG as well as audio data such as MP3. Also, the PMP has a large capacity storage device therein, so that the PMP is a mobile device that may be utilized as a good portable storage device.

Such a mobile device generally has a built-in speaker in order to ensure a small size of the device. However, an exterior speaker is recently used for improvement in the performance. Such an exterior speaker increases a volume of the device and deteriorates a front external appearance thereof.

In addition, recently, there is an increased demand on a mobile device with various functions with portability of the device emphasized as well as basic functions of a mobile device such as storage and playback of data.

### SUMMARY OF THE INVENTION

Accordingly, the present invention is conceived to solve the aforementioned problems in the prior art. An object of the present invention is to provide a mobile device, wherein a speaker is installed to a main body of the mobile device such that the speaker may be used as desired by a user.

Another object of the present invention is to provide a mobile device with a structure capable of performing various functions with portability emphasized.

According to an aspect of the present invention for achieving the objects, there is provided a mobile device, which comprises a main body having a display provided on a front surface thereof, a speaker pivotably connected to one side of the main body so that the main body is selectively supported on the ground stably, the speaker receiving a signal from the main body and forming a sonic wave to generate a sound.

A speaker seating portion may be concavely formed in a lower end of a rear surface of the main body, wherein the speaker comprises a pair of speakers respectively hinged to both side ends of the main body, and the speakers may pivot on the rear surface of the main body to protrude therefrom to support the main body on the ground.

A support surface may be formed on a lower end of the speaker to be in contact with the ground, and the support surface may be formed slantingly so that the main body is inclined at a predetermined slope with respect to the ground.

The speaker may be pivotably connected to the main body so that the speaker is folded on or unfolded with respect to the display of the main body.

The mobile device may further comprise a hinge for connecting the speaker with the main body, wherein the hinge may have both ends hinged through hinge shafts to hinge seating portions formed in one side ends of the speaker and the main body, respectively, and each of the speaker and the main body may be pivotable more than 180 degrees about each hinge shaft.

Engagement protrusions may be elastically supported on inner side surfaces of both ends of the hinge seating portion so that the engagement protrusions protrude, and concavo-convex portions may be formed in both the ends of the hinge so that the engagement protrusions are engaged with the concavo-convex portions, respectively, thereby allowing the speaker and the main body to be pivolable within a predetermined angle.

According to another aspect of the present invention, there is provided a portable digital device, which comprises a main body having a seating portion stepped on a rear surface thereof; and a speaker rotatably installed to the main body to be selectively positioned in the seating portion or a front surface of the main body, the speaker having a speaker grille formed on one surface thereof so that the speaker faces the seating portion in a state where the speaker is seated on the seating portion.

A support for selectively supporting the main body may be rotatably provided in the seating portion of the rear surface of the main body.

Protrusions may be respectively formed in the main body and the speaker at corresponding positions thereof, and connectors for connecting the protrusions may be rotatably provided at both side surfaces of the protrusions.

Contacts for electrically connecting the speaker to an inside of the main body may be formed on corresponding surfaces of the protrusions and connectors that are in contact with each other.

A support seating recess, in which the support is selectively seated, may be concavely formed in the rear surface of the main body having the seating portion formed therein.

An extension may be provided in the support, wherein the extension may be slidable into or out of the support to selectively extend a length of the support.

According to a further aspect of the present invention, there is provided a mobile device, which comprises a main body having one or more insertion portions concavely formed in one surface thereof; and a support plate partially inserted into one of the insertion portions to support the main body on the ground.

Inner surfaces of the insertion portions may have different tilt angles.

The insertion portion may have a first seating groove into which a relatively longer side of the support plate is inserted; and a second seating groove formed from the first seating groove more concavely by a predetermined depth toward the inside of the main body, wherein the second seating groove may have a relatively shorter length than the first seating groove so that a relatively shorter side of the support plate is inserted therein.

A cover made of a rubber material and having a shape corresponding to the insertion portion may be further provided in the insertion portion.

According to a still further aspect of the present invention, there is provided a mobile device, which comprises a main body; and a hanger rotatably coupled to an outside of the main body and having a catching portion provided in one side thereof, the hanger being caught to an external article.

The main body may be formed with a coupling portion to which the hanger is slidably coupled.

The mobile device may further comprise an elastic member having one side coupled to the hanger and the other side coupled to the main body, wherein the elastic member may provide elastic force in a direction in which the hanger is brought into close contact with the main body.

The hanger may comprise a pair of bodies, which are provided in both ends of the catching portion and coupled to both side surfaces of the coupling portion. The bodies may be respectively formed with coupling units to be coupled with the coupling portion, and a plurality of coupling holes may be formed in both the side surfaces of the coupling portion so that the coupling units are coupled to the coupling holes.

The main body may include a battery for supplying power and a battery cover selectively coupled to the main body to cover the battery, and the hanger may be positioned on a moving path of the battery cover in a process of separating the battery cover from the main body.

According to a still further aspect of the present invention, there is provided a mobile device, which comprises an upper unit defining an upper external appearance of the mobile device; and a lower unit coupled with the upper unit to define a lower external appearance of the mobile device, wherein one surface of the lower unit facing the upper unit is coupled to the upper unit to be spaced apart from the upper unit.

Coupling portions may be respectively provided in the upper and lower units to couple them, and a cover member may be coupled to the coupling portions to cover the coupling portions in a state where the coupling portions are coupled.

Anti-sliding units may be formed on surfaces of the upper and lower units, wherein the surfaces face each other.

The upper unit may have an inclined surface inclined outward as it goes from a lower side to an upper side, and the lower unit may have an inclined surface inclined outward as it goes from an upper side to a lower side.

### BRIEF DESCRIPTION OF THE DRAWINGS

FIG. 1 is an exploded perspective view showing a first embodiment of a mobile device according to the present invention.

FIG. 2 is a rear perspective view showing the first embodiment of the mobile device according to the present invention.

FIG. 3 is a perspective view showing that a speaker is used as a support in the first embodiment of the present invention.

FIG. 4 is a perspective view showing a second embodiment of the mobile device according to the present invention.

FIG. 5 is an exploded perspective view showing a binge employed in the second embodiment of the present invention.

FIGS. 6 and 7 are views showing a state where the second embodiment of the present invention is used.

FIG. 9 is an exploded perspective view showing a third embodiment of the mobile device according to the present invention.

FIGS. 9 and 10 are perspective views showing a standing state of the third embodiment of the mobile device according to the present invention.

FIGS. 11a to 11d are views showing a process in which a speaker is rotated according to the third embodiment of the present invention.

FIG. 12 is an exploded perspective view showing a fourth embodiment of the mobile device according to the present invention.

FIG. 13 is a transverse sectional view showing the fourth embodiment of the mobile device according to the present invention.

FIG. 14 is a longitudinal sectional view showing the fourth embodiment of the mobile device according to the present invention.

FIGS. 15 and 16 are perspective views showing a standing state of the mobile device according to the fourth embodiment of the present invention.

FIG. 17 is an exploded perspective view showing a fifth embodiment of the mobile device according to the present invention.

FIG. 18 is a perspective view showing a state where a hanger is coupled to a lower case in the fifth embodiment of the present invention.

FIGS. 19a to 19c are views showing a process where the mobile device stands according to the fifth embodiment of the present invention.

FIGS. 20a to 20c are views showing a process of separating a battery from the mobile device according to the fifth embodiment of the present invention.

FIG. 21 is an exploded perspective view showing a sixth embodiment of the mobile device according to the present invention.

FIG. 22 is a perspective view showing the sixth embodiment of the mobile device according to the present invention.

FIG. 23 is a side view showing the sixth embodiment of the mobile device according to the present invention.

### DESCRIPTION OF THE PREFERRED EMBODIMENT

Hereinafter, a first embodiment of a mobile device according to the present invention will be described in detail with reference to the accompanying drawings.

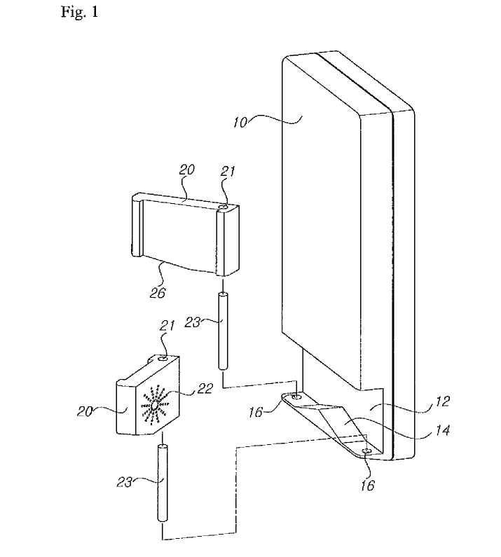

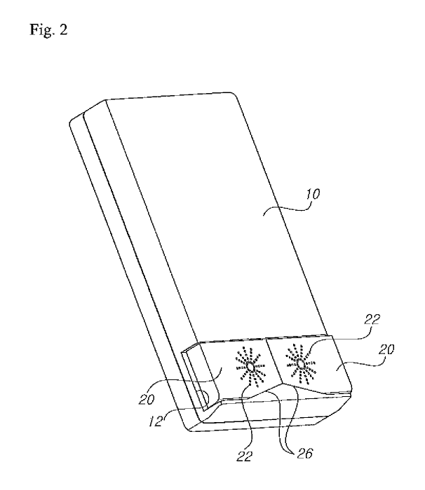

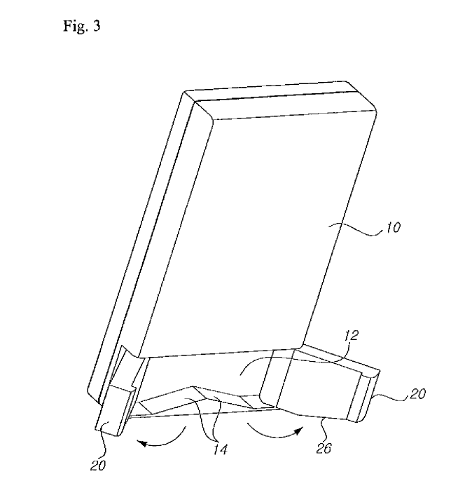

FIG. 1 is an exploded perspective view showing a mobile device according to the first embodiment of the present invention, FIG. 2 is a rear perspective view showing the first embodiment of the mobile device according to the present invention, and FIG. 3 is a perspective view showing that a speaker is used as a support in the first embodiment of the present invention.

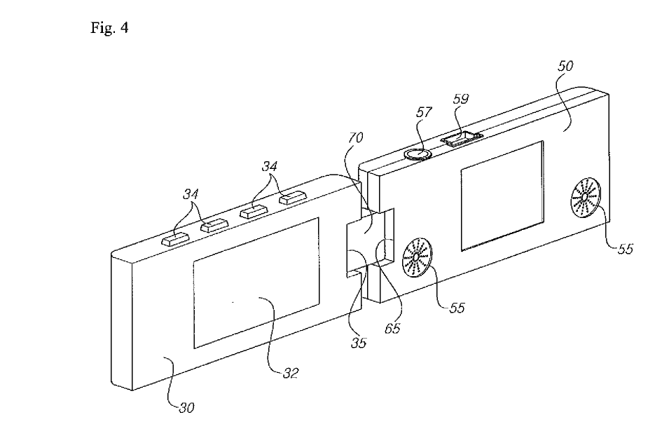

Referring to the figures, a main body 10 of the mobile device has a substantially flat rectangular hexahedral shape. Various components for operating the mobile device, such as a circuit board having parts mounted thereon and a battery, are provided in the main body 10. A display 11 (see FIG. 4) for displaying operational state or output information of the mobile device is provided in a front surface of the main body 10. The display 11 may also display input information of a user.

A speaker seating portion 12, on which a pair of speakers 20 to be explained later are placed, is concavely formed in a lower end of a rear surface of the main body 10. An inclined portion 14 inclined upward from both side ends of the speaker seating portion 12 to a center thereof is formed on an inner surface of the lower end of the speaker seating portion 12. The inclined portion 14 is corresponding to the lower ends of the speakers 20 in shape, so that the inclined portion 14 minimizes a gap in the rear surface of the main body 10 when the speakers 20 are seated on the speaker seating portion 12. Hinge recesses 16 are respectively concavely formed in upper and lower inner surfaces of both side ends of the speaker seating portion 12. A hinge shaft 23 to be explained later is inserted and fixed in each pair of the hinge recesses 16.

The pair of speakers 20 for generating sound are seated on the speaker seating portion 12. The speakers 20 are respectively hinged to be pivotable about both the side ends of the speaker seating portion 12. To this end, a hinge hole 21 is bored through one side end of each speaker 20, and the hinge shaft 23 is pivotably inserted in the hinge hole 21. Then, upper and lower ends of the hinge shaft 23 are respectively inserted and fixed in the hinge recesses 16. Power or signal transmitted from the main body 10 may be transmitted into the speaker 20 through the hinge shaft 23.

In a state where the speaker 20 is seated on the speaker seating portion 12, one surface of the speaker 20 defines a part of the rear surface of the main body 10. A grille portion 22 through which the sound generated in the speaker 20 is transmitted to the outside is formed on a surface of the speaker 20.

Meanwhile, the speaker 20 is rotated to protrude from the rear surface of the main body 10, so that the main body 10 can be stably supported on the ground. That is, the pair of speakers 20 respectively pivot oil the hinge shafts 23 and thus protruded from the rear surface of the main body 10. Then, if bottoms of the speakers 20 are placed on the ground, the main body 10 may keep its standing state since the speakers 20 are placed on the ground in a state of being connected to the main body 10. The speaker 20 is preferably pivotable more than 90 degrees on the speaker seating portion 12. When the speakers 20 are rotated up to a maximum angle, the grills 22 formed on one surfaces of the speakers 20 are directed to the front of the main body 10.

In addition, a support surface 26 is formed on a lower end of each speaker 20 to maximize a contact area with the ground so that the main body 10 may be stably supported. The support surface 26 is inclined from one end of the speaker 20 where the hinge hole 21 thereof is formed toward the other end. Since the support surface 26 is slantingly formed, the main body 10 may be supported on the ground with a slope.

Hereinafter, the operation of the first embodiment of the mobile device according to the present invention configured as mentioned above will be described in detail.

According to the present invention, the speaker 20 functions as a support that supports the main body 10. The process of using the speaker 20 as a support will be described with reference to FIGS. 2 and 3.

At an ordinary time when the speakers 20 are not used, the speakers 20 are seated on the speaker seating portion 12 as shown in FIG. 2. At this time, one surfaces of the speakers 20 define a plane, which is flush with the rear surface of the main body 10. Also, if the speakers 20 are seated on the speaker seating portion 12, the speakers 20 are not observed from the front of the main body 10, so the a front design of the main body 10 is kept neatly.

When it is intended to generate a sound to the outside through the speakers 20 or use the main body 10 in a standing state, the speakers 20 pivot on the hinge shafts 23 as shown in FIG. 3. Then, the speakers 20 go out of the speaker seating portion 12 and protrude to the rear of the main body 10, and the support surfaces 26 at the lower ends of the speakers 20 are in close contact with the ground, thereby supporting the main body 10. At this time, the grille portions 22 formed on the surfaces of the speakers 20 are directed to the front of the main body 10, so that the sound is transmitted to the front of the main body 10.

Hereinafter, a second embodiment of the mobile device according to the present invention will be described.

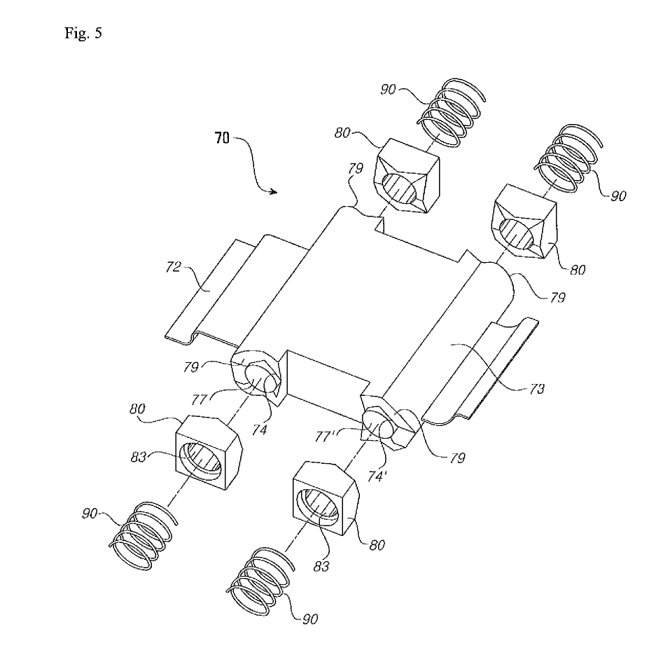

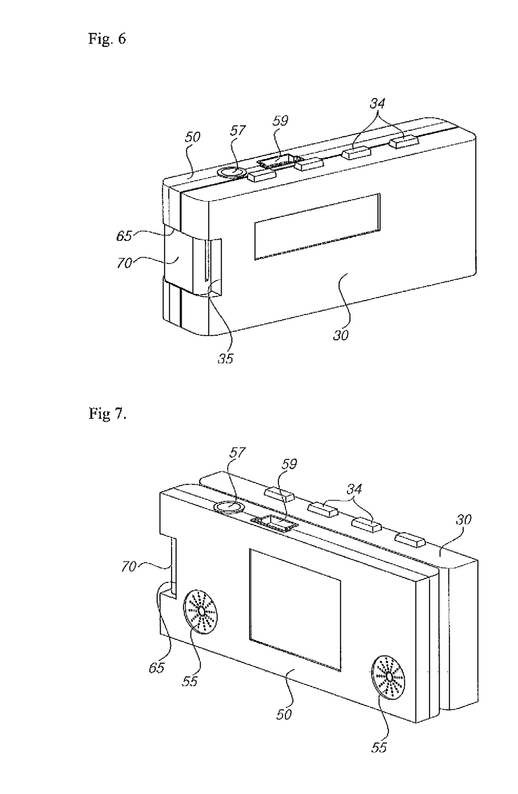

FIG. 4 is a perspective view showing the second embodiment of the mobile device according to the present invention, FIG. 5 is an exploded perspective view showing a hinge employed in the second embodiment of the present invention, and FIGS. 6 and 7 are views showing a state where the second embodiment of the present invention is used.

As shown in the figures, the second embodiment of the mobile device according to the present invention includes a main body 30 having a display 32 provided on a front surface thereof, a speaker 50 pivotable on the main body 30 such that the speaker 50 may be folded on or unfolded with respect to the display 32 of the main body 30, and a hinge 70 for connecting the main body 30 with the speaker 50.

The main body 30 has a substantially flat rectangular hexahedral shape, and the display 32 is provided in the front surface of the main body 30 so as to display output or input information. Also, a plurality of buttons 34 for inputting operating instructions are provided in one side of the main body 30. In addition, a hinge seating portion 35 is formed at one side end of the main body 30 such that one end of the hinge 70 to be explained later may be placed thereon.

In this embodiment, the speaker 50 has a substantially flat rectangular hexahedral shape and corresponds to the main body 30 in size. The speaker 50 serves to generate a sonic wave using a signal transmitted from the main body 30 and then producing a sound. Grille portions 55 for outputting a sound forward are formed on a surface of the speaker 50 corresponding to the display 32. Also, an earphone jack 57 and a USB port 59 are provided in one side of the speaker 50. In addition, a battery pack for supplying the main body 30 and the speaker 50 with power may be provided in the speaker 50. A hinge seating portion 65 is formed at one side end of the speaker 50 such that the other end of the hinge 70 to be explained later is placed thereon.

The speaker 50 pivots on the hinge 70, which will be described later, so as to be folded on or unfolded with respect to the display 32 of the main body 30. In addition, referring to FIG. 4, the speaker 50 is pivotable such that a rear surface of the speaker 50 opposite to the surface where the grille portions 55 are formed is overlapped with the rear surface of the main body 30.

The hinge 70 is provided between the main body 30 and the speaker 50, and both ends of the hinge 70 are respectively hinged to the hinge seating portion 35 of the main body 30 and the hinge seating portion 65 of the speaker 50. The main body 30 and the speaker 50 may respectively pivot on hinge shafts 77 and 77′, which will be described later, 180 degrees or more.

The configuration of the hinge 70 will be described in more detail. The hinge 70 has a hinge body 73 with a substantially rectangular hexahedral shape, as shown in FIG. 5. A flexible cable 72 is provided to pass through the inside of the hinge body 73. The flexible cable 72 is used for electrically connecting the main body 30 with the speaker 70.

Hinge holes 74 and 74′ are respectively bored through both side ends of the hinge body 73. Also, hinge shafts 77 and 77′ are rotatably inserted in the hinge holes 74 and 74′, respectively. Both ends of the hinge shaft 77 respectively protrude from the hinge hole 74 and then inserted and fixed in both inner side surfaces of the hinge seating portion 35 of the main body 30. Also, both ends of the hinge shaft 77′ respectively protrude from the hinge hole 74′ and then inserted and fixed in both inner side surfaces of the hinge seating portion 65 of the speaker 50.

In this embodiment, the hinge 70 is configured to control a rotational angle of the main body 30 and the speaker 50. For example, as shown in FIG. 5, coneavo-convex portions 79 are respectively formed at ends of both the sides of the hinge body 73 corresponding to the inner side surfaces of the hinge seating portions 35 and 65. The concavo-convex portions 79 are shaped to be selectively engaged with engagement protrusions 80, which will be described later.

The engagement protrusions 80 are elastically supported by elastic members 90, which will be described later, so as to protrude from both the inner side surfaces of each hinge seating portion 35 or 65. The engagement protrusions 80 are supported by the elastic members 90 to be movable in a direction of protruding from both the inner side surfaces of each hinge seating portion 35 or 65 and installed rotatably together with the main body 30 and the speaker 50. A through hole 83 is bored through the center of the engagement protrusion 80. Also, the ends of the hinge shafts 77 and 77′ are positioned through the through hole 83 of the engagement protrusion 80.

The elastic members 90 are respectively installed in inner spaces of both the side surface of each hinge seating portion 35 or 65 and serve to provide elastic force such that the engagement protrusions 80 protrude from both the inner side surfaces of each hinge seating portion 35 or 65.

The operation of the second embodiment of the mobile device according to the present invention configured as mentioned above will be described.

FIGS. 6 and 7 show examples of using the mobile device. In this embodiment, the main body 30 and the speaker 50 respectively pivot on the hinge shafts 77 and 77′. At this time, one surface of the speaker 50 may be overlapped with the display 32 of the main body 30, as shown in FIG. 6, or the other surface of the speaker 50 may be overlapped with the rear surface of the main body 30 where the display 32 is not formed, as shown in FIG. 7.

Meanwhile, in this embodiment, rotating angles of the main body 30 and the speaker 50 are regulated by means of the concavo-convex portions 79 and the engagement protrusions 80 of the hinge 70. That is, while the engagement protrusions 80 are elastically supported by the elastic members 90 to protrude from both the inner side surfaces of each hinge seating portion 35 or 65, the engagement protrusions 80 are engaged with the concavo-convex portions 79 to regulate the rotation of the main body 30 and the speaker 50. In addition, if the speaker 50 is rotated as much as a predetermined angle with respect to the hinge shaft 77′, the engagement protrusions 80 overcome the elastic force of the elastic members 90 and thus are inserted into the speaker 50. Thus, the engagement between the concavo-convex portion 79 and the engagement protrusion 80 is released. Then, if the concavo-convex portion 79 and the engagement protrusion 80 are relatively rotated to engage with each other, the speaker 50 cannot be rotated further if the force capable of releasing the engagement between the concavo-convex portion 79 and the engagement protrusion 80 is not applied thereto. In this way, the main body 30 and the speaker 50 may be rotated with respect to each other by a predetermined angle.

Hereinafter, a third embodiment of the mobile device according to the present invention will be described.

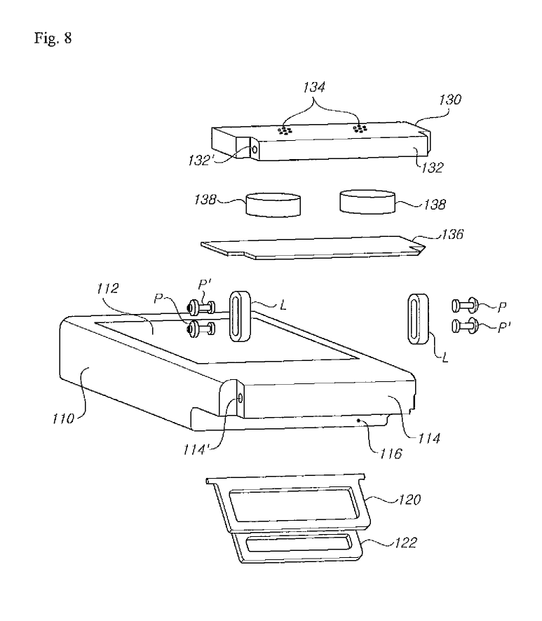

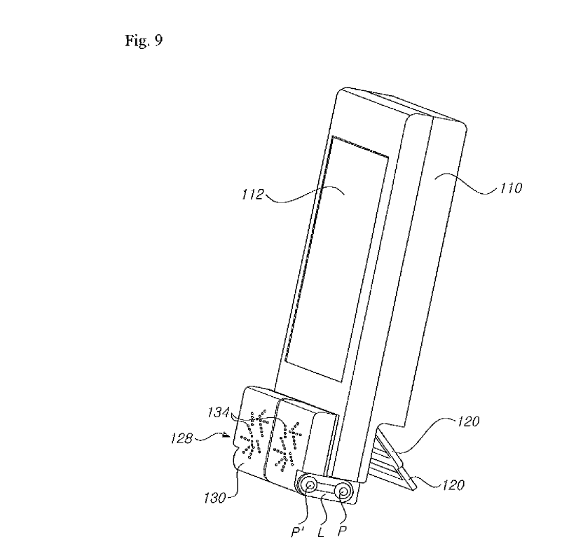

FIG. 8 is an exploded perspective view showing the third embodiment of the mobile device according to the present invention, and FIGS. 9 and 10 are perspective views showing a standing state of the third embodiment of the mobile device according to the present invention.

Referring to the figures, the main body 110 defining an external appearance of the mobile device has a substantially rectangular hexahedral shape. A display 112 having a substantially quadrangular shape is provided in a front surface of the main body 110. The display 112 comprises a liquid crystal panel provided in the main body 110 and the like, and is partially transparent so that contents displayed on the liquid panel may appear on the front surface of the main body 110. The display 112 displays an operational state of the mobile device or an image played by executing a multimedia file.

The display 112 of a touch screen manner is used for a light and compact of the mobile device. Generally, a touch screen is configured by providing an LCD (Liquid Crystal Display) panel to a rear surface of a touch glass with electrodes printed or vacuum deposited on a surface thereof. Such a touch screen module may be easily configured by those skilled in the art, so that detailed descriptions thereon will be omitted.

A first protrusion 114 is formed to protrude from one end of the main body 110. Both side surfaces of the first protrusion 114 are stepped from the main body 110. A part of a connector L, which will be described later, is positioned on each of both the side surfaces of the first protrusion 114.

First hinge holes 114′ are concavely formed in both the side surfaces of the first protrusion 114. The connector L of a hinge pin P to be explained later is inserted into the first hinge hole 114′ to pass therethrough.

A seating portion 116 is formed on a rear surface of the one end of the main body 110 where the first protrusion 114 is formed such that the seating portion 116 is stepped from the main body 110. A speaker 128, which will be described later, is selectively seated on the seating portion 116.

A support seating recess 118 is concavely formed in the rear surface of the main body 110, where the seating portion 116 is formed, as shown in FIG. 10. A support 120, which will be described later, is selectively seated in the support seating recess 118.

The support 120 is rotatably provided in the support seating recess 118. The support 120 has a substantially quadrangular plate shape. The support 120 is rotated to make a predetermined slope with respect to the main body 110. As mentioned above, the support 120 selectively supports the main body 110 to function as a standing pole.

An extension 122 is provided at one end of the support 120. The extension 122 is coupled to slide into or out of the support 120. When certain force is applied to the extension 122, the extension 122 slides into or out of the support 120. When the extension 122 together with the support 120 supports the main body 110, the extension 122 does not slide into or out of the support 120 only by the self weight of the main body 110. The extension 122 is selectively used to make a suitable slope according to a usage environment of the mobile device.

The support 120 may has a blank central portion as shown in FIG. 8 so as to reduce its material. When not used, the support 120 is seated in the support seating recess 118.

The connector L is rotatably installed to the main body 110 through the hinge pin P. More specifically, in a state where the connector L is positioned at a side of the first protrusion 114, the hinge pins P and P′ pass through a center portion of the connector L, and both inner ends of the connector L are supported by the hinge pins P and P′. The hinge pins P and P′ are respectively inserted into the first hinge hole 114′ and a second hinge hole 132′, which will be described later. The connector L rotates on the hinge pin P inserted into the first hinge hole 114′ as a central axis.

The connector L preferably has rounded edges such that the connector L may rotate with respect to the main body 110 and the speaker 128 to be described later. However, the connector L does not rotate only by the self weight of the main body 110 or the speaker 128, but the connector L rotates only when certain external force is applied thereto.

The connector L is provided with a configuration for electrically connecting a speaker unit 138, which will be described later, to a main board (not shown) provided in the main body 110. For example, contacts (not shown) are respectively provided in both corresponding sides of the first protrusion 114 and the connector L that are in contact with each other, so that an electric signal of the main board can be transmitted to the speaker unit 138. These contacts are configured not to change their positions even when the connector L is rotated. Such a configuration is also applied to a relationship between a second protrusion 132 to be explained later and the connector L.

Meanwhile, the speaker 128 is rotatably installed to the main body 110. An external appearance of the speaker 128 is defined by a speaker case 130 and a base plate 136.

The speaker case 130 has a substantially rectangular hexahedral shape. The speaker case 130 is connected to the main body 110 through the connectors L. The second protrusion 132 is stepped at one end of the speaker case 130, which is corresponding to the first protrusion 114. Portions of the connectors L are positioned at both sides of the second protrusion 132.

Second hinge holes 132′ are concavely formed in both the sides of the second protrusion 132. The hinge pins P′ are inserted into the second hinge holes 132′ through the connectors L, respectively.

Speaker grilles 134 are formed on an upper surface of the speaker case 130. There are provided a plurality of the speaker grilles 134 to pass through the speaker case 130. The speaker grilles 134 allow a voice signal generated from the speaker unit 138, which will be described later, to be transmitted to the outside.

The base plate 136 is provided in a bottom surface of the speaker case 130. The base plate 136 forms a predetermined inner space in cooperation with the speaker case 130. The base plate 136 has a rectangular hexahedral shape in correspondence with the speaker case 130. The base plate 136 may also be integrally formed with the speaker case 130 according to a design condition.

The speaker units 138 are provided on the base plate 136. The speaker unit 138 converts an electric signal into a voice signal. The speaker unit 138 generates vibration of air to generate a voice signal. The speaker unit 138 is provided with a configuration for electrically connecting to the main board provided in the main body 110. For example, a wire (not shown) for connecting the speaker unit 138 with the main board is connected into the main body 110 through the connector L.

Now, the operation of the third embodiment of the mobile device according to the present invention will be described.

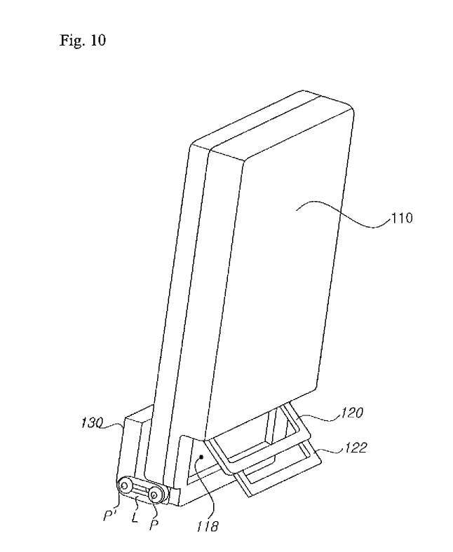

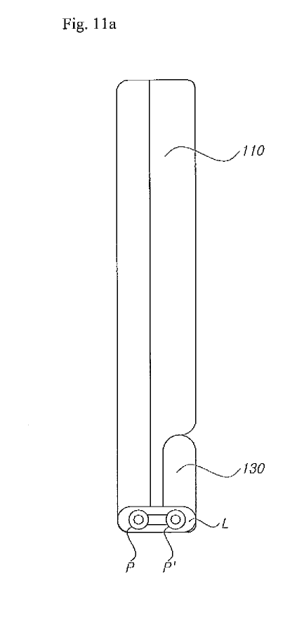

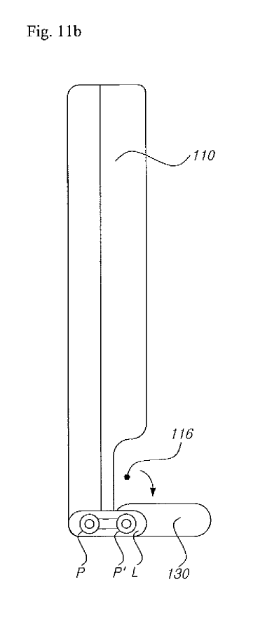

FIGS. 11a to 11d are views showing a process in which a speaker is rotated according to the third embodiment of the present invention.

As shown in FIG. 11a, when a user desires to output a voice through an earphone without using the speaker 128, the speaker 128 is seated in the seating portion 116. For using the speaker 128 instead of the earphone, the user rotates the speaker 128 clockwise with the hinge pins P′ as a central axis, as shown in FIG. 11b. At this time, the speaker 128 is out of the seating portion 116 and is positioned on an extension line of the connector L.

In this state, the connectors L are rotated together with the speaker 128 clockwise about the hinge pins P. At this time, the speaker 28 moves to the front of the main body 110, as shown in FIG. 11c.

In a state where the speaker 128 moves to the front of the main body 110, if the speaker 128 is rotated once more about the hinge pin P′, the speaker 128 becomes perpendicular to the connector L. At this time, the speaker grille 134 of the speaker 128 is positioned toward the same direction as the front of the main body.

In this state, in order to stand the main body 110 on a table or the like, the support 120 seated in the support seating recess 118 is rotated counterclockwise. If the support 120 is out of the support seating recess 118 and is positioned at the rear of the main body 110, a user may operate the mobile device in a standing state on a table or the like, which is shown in FIG. 11d.

As mentioned above, when the mobile device is not used or an earphone is used, the speaker 128 is positioned in the rear of the main body 110, thereby ensuring a neat design of the external appearance of the mobile device.

In addition, when a user intends to use the speaker 128, the speaker 128 is positioned in the front of the main body 110 to output a voice, and at the same time, the mobile device is inclined, so that the mobile device may stand on a table or the like while the user watches a DMB broadcast or the like.

Hereinafter, a fourth embodiment of the mobile device according to the present invention will be described.

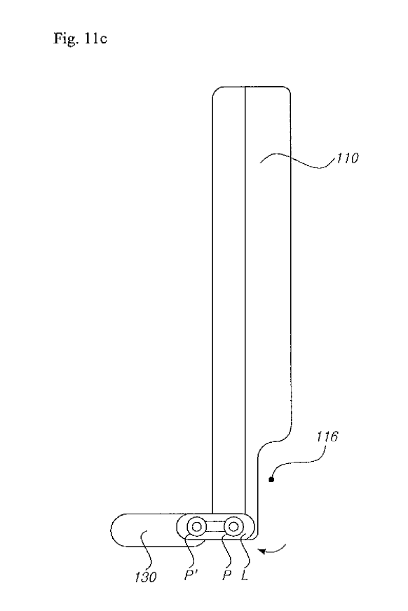

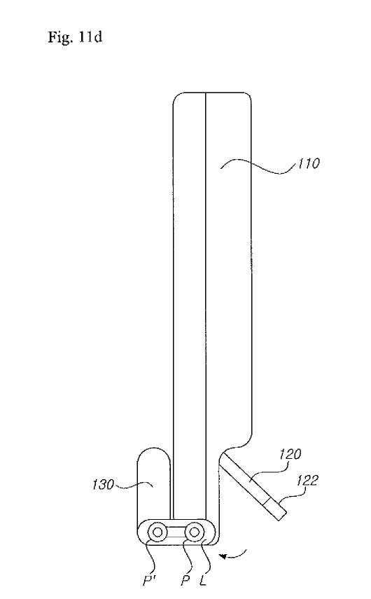

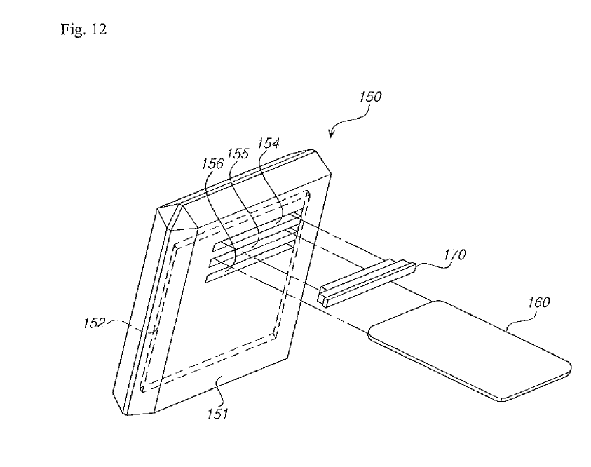

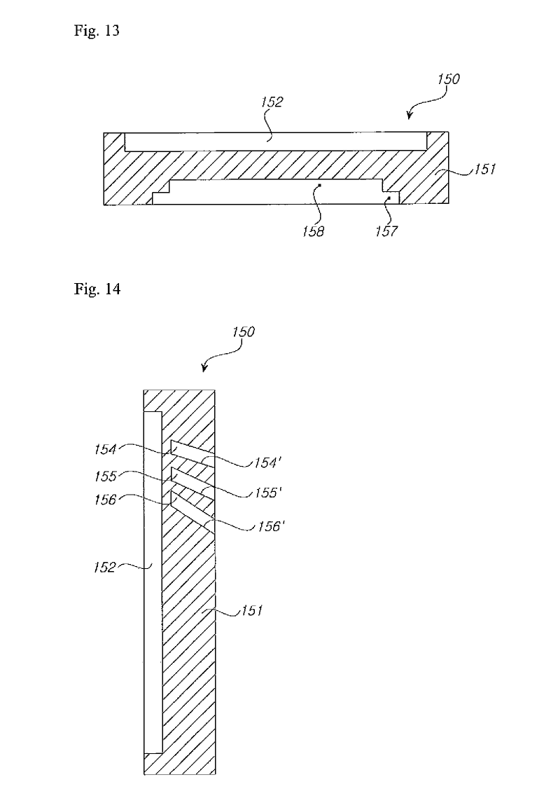

FIG. 12 is an exploded perspective view showing the fourth embodiment of the mobile device according to the present invention, FIG. 13 is a transverse sectional view showing the fourth embodiment of the mobile device according to the present invention, and FIG. 14 is a longitudinal sectional view showing the fourth embodiment of the mobile device according to the present invention.

Referring to the figures, a main body 151 defines an overall external appearance and a framework of a mobile device 150. The main body 151 has a substantially flat hexahedral shape, and various components and boards are installed therein. A display 152 is provided in a front surface of the main body 151. The display 152 displays an operational state of the mobile device 150 or a digital image. As the display 152, an LCD is generally used.

One or more insertion portions 154, 155 and 156 are formed in a rear surface of the main body 151, i.e., a surface opposite to the display 152. The insertion portions 154, 155 and 156, into any one of which a support plate 160 to be explained later is inserted, are formed to extend in a horizontal direction. The insertion portions 154, 155 and 156 are concavely formed in the rear surface of the main body 151 by a predetermined depth to be open toward the front.

As shown in FIG. 13, a first seating groove 157 is formed in each insertion portion 154, 155 or 156. The first seating groove 157 is concavely formed toward the inside of the main body 151 by a predetermined depth. Also, the first seating groove 157 has a shape corresponding to a relatively longer side of the support plate 160.

In addition, a second seating groove 158 is formed from the first seating groove 157 more concavely by a predetermined depth toward the inside of the main body 151. The second seating groove 158 is formed with a relatively shorter length than the first seating groove 157, so that the second seating groove 158 is stepped from the first seating groove 157. The second seating groove 158 is formed corresponding to a relatively shorter side of the support plate 160 in shape. The first and second seating grooves 157 and 158 are formed with different lengths, so that the mobile device 150 can be stood at various angles.

Meanwhile, inner surfaces of the insertion portions 154, 155 and 156 are inclined surfaces 154′, 155′ and 156′ with different tilt angles, as shown in FIG. 14. Thus, a user may insert the support plate 160 to any one of the insertion portions 154, 155 and 156 with a desired angle to support the main body 151.

The support plate 160 is selectively inserted into any one of the insertion portions 154, 155 and 156. In this embodiment, a card which a user ordinarily carries and uses is used as the support plate 160. For example, a rectangular flat card made of plastic, such as a credit card or a cash card, may be used. Of course, any plate capable of supporting the weight of the mobile device 150 may be used as the support plate 160.

The insertion portion 154, 155 or 156 is provided with a cover 170 as shown in FIG. 12. The cover 170 is used for preventing foreign materials such as dust from being introduced into the insertion portion 154, 155 or 156 while the support plate 160 is not inserted into the insertion portion 154, 155 or 156. The cover 170 is made of a rubber material and preferably formed in the shape corresponding to the first to third insertion portions 154, 155 and 156.

The operation of the fourth embodiment of the mobile device according to the present invention will be described.

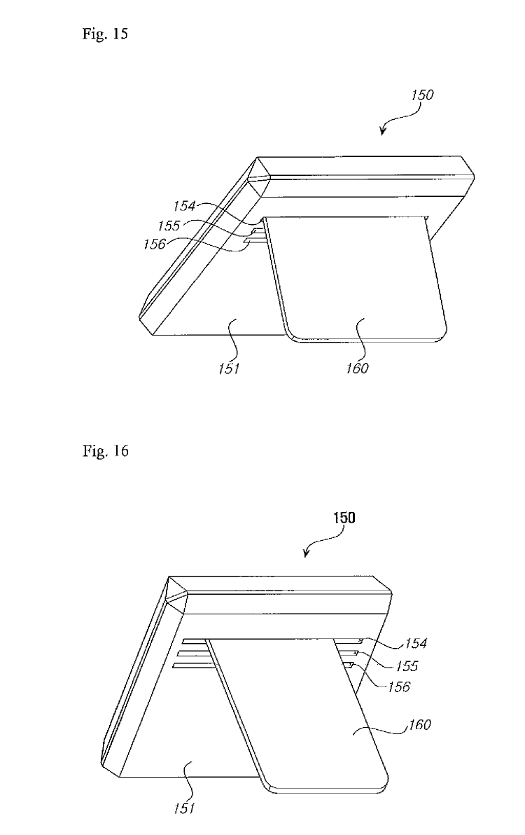

First, when a user desires to use the mobile device 150 in a standing state, the user separates the cover 170 provided in one of the insertion portions 154, 155 and 156, into which the support plate 160 will be inserted, from the main body 151. Then, the user selects one of the first and second seating grooves 157 and 158 for fixing the support plate 160. At this time, when the user selects the first seating groove 157, a relatively longer side of the support plate 160 is inserted into the first seating groove 157, which is shown in FIG. 15. On the contrary, if the user selects the second seating groove 158, a relatively shorter side of the support plate 160 is inserted into the second seating groove 158, as shown in FIG. 16. In this way, a standing angle of the main body 151 may be controlled according to an inserted side of the support plate 160.

In this embodiment, the mobile device 150 may be used at six angles according to an inserted side of the support plate 160 and a position of the insertion portions 154, 155 and 156 into which the support plate 160 is inserted.

Then, the user places the main body 151 on a flat surface such as a table, with the support plate 160 inserted therein. At this time, the main body 151 is supported at a predetermined angle by means of the support plate 160.

Hereinafter, a fifth embodiment of the mobile device according to the present invention will be described.

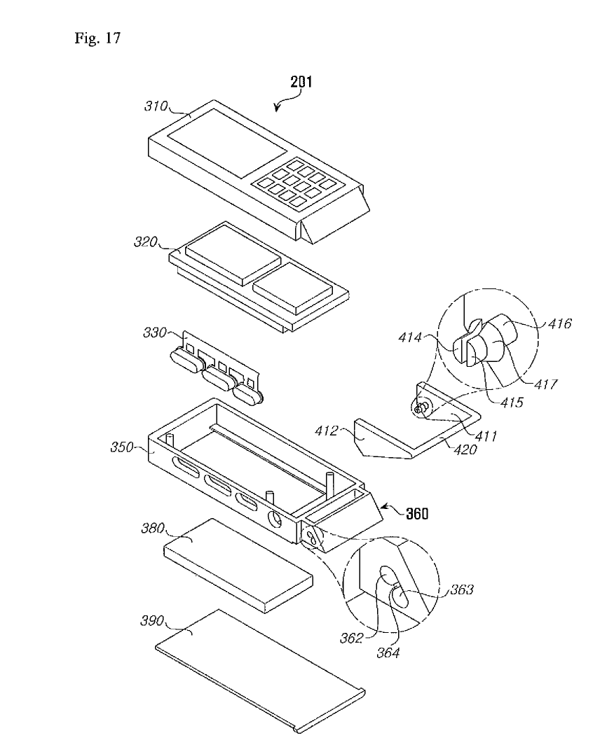

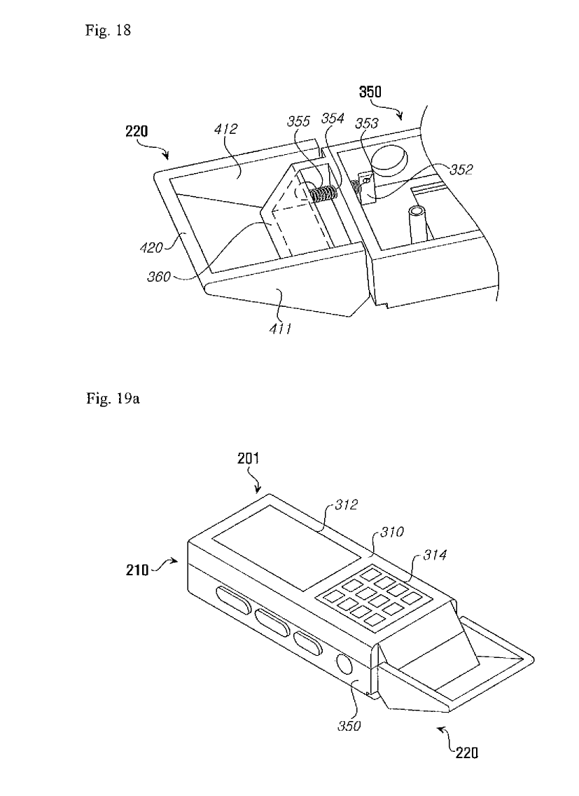

FIG. 17 is an exploded perspective view showing the fifth embodiment of the mobile device according to the present invention, and FIG. 18 is a perspective view showing a state where a hanger is coupled to a lower case in the fifth embodiment of the present invention.

Referring to the figures, a mobile device 201 of this embodiment includes a main body 210 defining an external appearance of the mobile device, and a hanger 220 rotatably coupled to one side of the main body 210 such that the main body 210 can be caught to a hook or the like.

The main body 210 comprises an upper case 310 and a lower case 350. Also, the hanger 220 is rotatably coupled to the lower case 350.

A display 312 for displaying an operational state of the mobile device 201 and an input unit 314 for inputting operational conditions of the mobile device 201 by a user are formed on an upper surface of the upper case 310. Here, although not shown, the mobile device 201 may be further provided with a voice output unit for outputting voice information and a voice input unit for inputting voice information.

A battery is received in the lower case 350, and a battery cover 390 for selectively covering the battery is slidably coupled to a rear surface of the lower case 350.

The hanger 220 is formed with a catching portion 420 that can be caught to an external article.

Thus, a user may keep the mobile device 201 in a caught state to an article having a hook, for example a bag. In addition, a hand strap may be connected to the catching portion 420.

Referring to FIG. 17, the mobile device 201 of this embodiment includes the upper case 310, the lower case 350 coupled to the upper case 310, a PCB assembly 320 received in a space defined by the upper case 310 and the lower case 350, a button unit 330 allowing the mobile device 201 to be conveniently operated, a battery 380 for supplying power, the battery cover 390 coupled to the lower case 350 to cover the battery 380, and the hanger 220 coupled to the lower case 350.

Specifically, a coupling portion 360 is formed on the lower case 350 such that the hanger 220 is coupled thereto. Also, the coupling portion 360 is formed to protrude out of the lower case 350.

Hereinafter, a coupling configuration of the coupling portion 360 and the hanger 220 will be described in detail.

The hanger 220 includes a pair of bodies 411 and 412 defining an external appearance of the hanger 220, and the catching portion 420 connecting the pair of bodies 411 and 412 to each other.

Specifically, the pair of bodies 411 and 412 are spaced apart from each other by a predetermined distance, and the catching portion 420 is provided between the bodies 411 and 412. Each body 411 or 412 has a plate shape, and the catching portion 420 has a cylindrical shape. Also, the catching portion 420 has both ends formed at one side ends of the respective bodies 411 and 412.

In addition, a coupling unit for coupling to the coupling portion 360 is formed at each body 411 and 412. The coupling units extend toward each other. That is, the coupling unit formed at one of the bodies extends toward the other of them, and the coupling unit formed at the other thereof extends toward the one of them.

Also, the coupling unit has a pair of coupling projections 414 and 415. Each of the pair of coupling projections 414 and 415 has a shape corresponding to each other, and they are spaced apart from each other by a predetermined distance. That is, a space is defined between the coupling projections 414 and 415.

In addition, each coupling projection 414 or 415 includes a first extension 416 extending from the body 411 or 412, and a second extension 417 extending from the first extension 416 and having a diameter greater than the first extension 416.

The first extension 416 has a semicircular cross section. Also, the second extension 417 is gradually decreased in diameter as it becomes more distant from the first extension 416.

As mentioned above, each coupling unit is configured to have the pair of coupling projections 414 and 415, and each coupling projection 414 or 415 is composed of the first extension 416 and the second extension 417, so that each coupling projection 414 or 415 can be elastically deformable.

Meanwhile, the coupling portion 360 has a width corresponding to the distance between the pair of bodies 411 and 412. Also, a plurality of coupling holes are formed in both side surfaces of the coupling portion 360 such that the coupling units are coupled thereto.

Specifically, the coupling holes include a first coupling hole 362 and a second coupling hole 363 spaced apart from the first coupling hole 362. Also, the coupling holes 362 and 363 are connected with each other by means of a connection hole 364.

Each of the first and second coupling holes 362 and 363 is formed to have a diameter greater than a diameter of the first extension 416 and equal to or smaller than a diameter of the second extension 417. Also, the connection hole 364 is formed to have a size corresponding to the first extension 416.

Thus, in a process of coupling the pair of coupling projections 414 and 415 to the coupling hole 362 or 363, if the second extensions 417 are brought into contact with the coupling hole 362 or 363, the second extensions 417 are elastically deformed to approach each other and thus pass through the coupling hole 362 or 363. Then, after the second extensions 417 pass through the coupling hole 362 or 363, the second extensions 417 are restored to their original state. Thus, in a state where the coupling projections 414 and 415 are coupled to the coupling hole 362 or 363, the coupling projections 414 and 415 are prevented from escaping outward.

In addition, if the coupling projections 414 and 415 are coupled into any one of the coupling holes 362 and 363, the coupling projections 414 and 415 may move the other of the coupling holes 362 and 363 by moving the first extension 416 along the connection hole 364.

Also, an elastic member 355 is coupled to any one of the pair of coupling projections 414 and 415. Specifically, a support member 352 for supporting the elastic member 355 is formed inside of the lower case 350. Also, one end of the elastic member 355 is coupled to a catching hole 353 formed in the support member 352.

In addition, the other end of the elastic member 355 is coupled to the coupling projection through a through hole 354 formed in the lower case 350. Here, the elastic member 355 is coupled to the coupling projection 414 adjacent to the lower case 350 among the coupling projections 414 and 415.

Thus, the elastic member 355 elastically supports the coupling unit and also keeps the coupling unit to be positioned in the first coupling hole 362. That is, the elastic member 355 provides elastic force in a direction in which the hanger 220 is brought into close contact with the main body 210.

The operation of the fifth embodiment of the mobile device according to the present invention configured as mentioned above will be described.

First of all, the hanger 220 allows the catching portion 420 to be caught to a hook or the like as mentioned above, or to be caught to another article. The function of such a hanger 220 may be clearly understood from the shape of the hanger 220.

At this time, in order to ensure the hooking function of the catching portion 420, the catching portion is formed to be spaced apart from the coupling portion 360 by a predetermined distance.

In addition, the hanger 220 supports the mobile device 201 in a state where the hanger 220 is rotated a predetermined angle with respect to the mobile device 201. The rotating process of the hanger will be described with reference to the drawings.

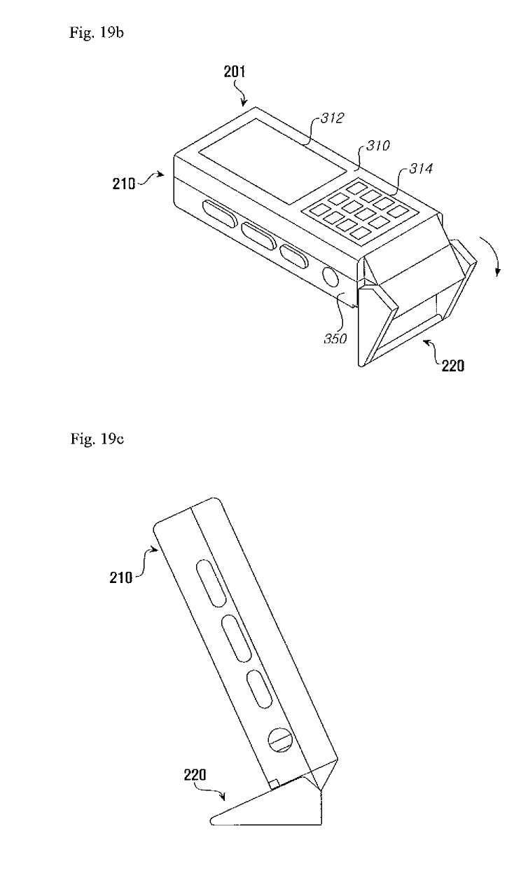

FIGS. 19a to 19c are views showing a process where the mobile device stands according to the fifth embodiment of the present invention.

Referring to the figures, the hanger 220 is firstly pulled out of the mobile device 201 in order to rotate the hanger 220. Then, the coupling unit which has been positioned in the first coupling hole 362 passes over the connection hole 364 and is then positioned in the second coupling hole 363. Thereafter, the hanger 220 is rotated downward as shown in FIG. 19b. At this time, in a process where the hanger 220 is pulled and rotated, the elastic member 355 is stretched.

Then, if the hanger 220 is seated on the ground as shown in FIG. 19c in a state where the hanger 220 is rotated with respect to the mobile device 201, the mobile device 201 is supported to the hanger 220. Here, the hanger 220 is parallel to the ground in the state shown in FIG. 19c. Thus, the mobile device 201 may be stably supported by the hanger 220, and a user may conveniently watch a moving picture or a satellite broadcast in the state shown in FIG. 19c.

Meanwhile, in order to restore the hanger 220 to its original position, the hanger 220 is rotated upward. Then, the elastic restoring force of the elastic member 355 causes the hanger 220 to be smoothly rotated. Also, while the hanger 220 is rotated, the coupling unit which has been positioned in the second coupling hole 363 passes through the confection hole 364 and is then positioned in the first coupling hole 362.

In the meantime, the hanger 220 prevents the battery cover 390 from being easily separated from the lower case 350. Hereinafter, the operation of the hanger in a process of separating the battery will be described with reference to the drawings.

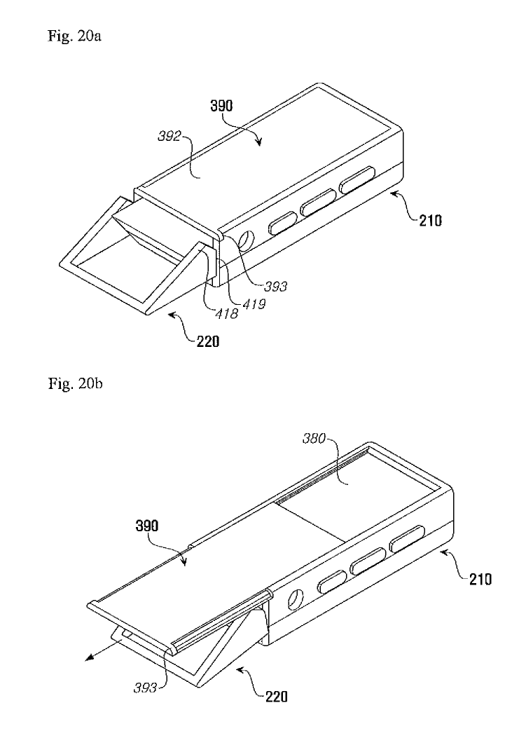

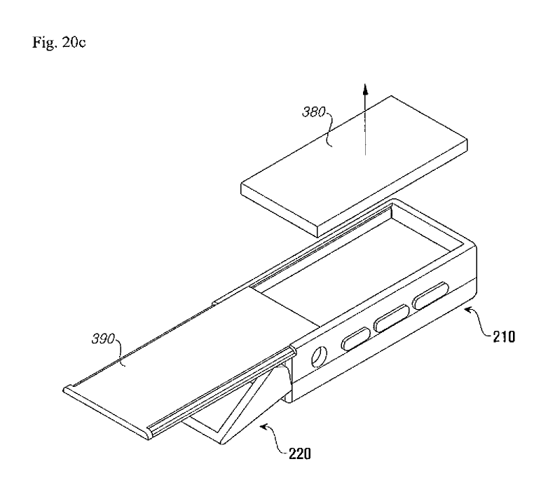

FIGS. 20a to 20c are views showing a process of separating a battery from the mobile device according to the fifth embodiment of the present invention.

Referring to the figures, in a state where the coupling unit is positioned in the first coupling hole 362, one end of each body 411 or 412 is positioned flush with the rear surface of the lower case 350.

In addition, the battery cover 390 includes a battery body 392 having a plate shape, and a pair of protrusions 393 extending in a horizontal direction from both sides of one end of the battery body 392. Also, the protrusions 393 are coupled to the lower case 350 in a state where the battery cover 390 slides and is completely inserted into the lower case 350.

Further, the battery body 392 of the battery cover 390 has a width corresponding to a distance between the pair of bodies 411 and 412 of the hanger 220.

According to such a configuration, if the battery cover 390 is pulled toward the hanger 220 in a state where the hanger 220 is positioned as shown in FIG. 20a, the protrusions 393 interfere with ends 418 of the bodies 411 and 412 of the hanger 220, so that the battery cover 390 is not separated.

That is, since the bodies 411 and 412 of the hanger 220 are positioned on a moving path of the protrusions 393, the protrusions 393 are caught to the hanger 220, whereby the battery cover 390 is not separated.

Thus, in order to separate the battery cover 390 from the lower case 350, the hanger 220 is firstly rotated downward (counterclockwise in FIG. 20a). Here, as shown in FIG. 20a, a surface 419 of the hanger 220, which faces the mobile device 201, is spaced apart from the mobile device 201 by a predetermined distance. Thus, the hanger 220 is rotated downward about the coupling units as a rotating axis by a predetermined angle.

Then, the ends of the hanger 220 are positioned relatively below the protrusions 393 of the battery cover 390. Thus, in a process of separating the battery cover 390, the protrusions 393 do not interfere with the ends 418 of the bodies 411 and 412 of the hanger 220.

Thereafter, the battery cover 390 is pulled toward the hanger 220 to be separated from the lower case 350, hi addition, in a state where the battery cover 390 is separated, the battery 380 is separated from the lower case 350.

Hereinafter, a sixth embodiment of the mobile device according to the present invention will be described.

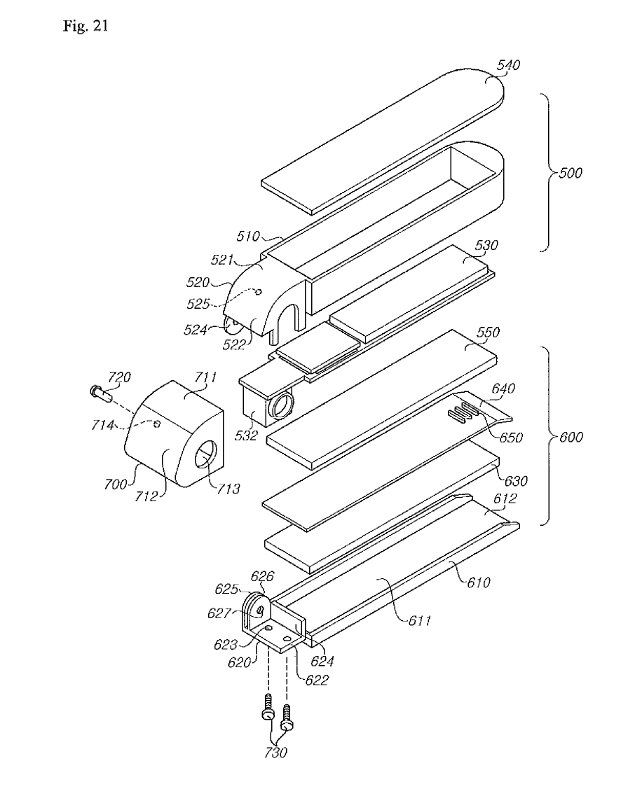

Referring to FIG. 21, the mobile device of this embodiment includes an upper unit 500, a lower unit 600 coupled with the upper unit 500 and having an upper surface spaced apart from a lower surface of the upper unit 500, and a cover member 700 coupled to a coupling portion of the upper unit 500 and the lower unit 600. Thus, from a point of view of the mobile device, a space S is formed in a main body of the mobile device such that an external article such as a collar of a coat can be inserted (see FIG. 23).

Here, the external article may correspond to a collar or a pocket portion, and hereinafter, a collar as an example of the external article will be described.

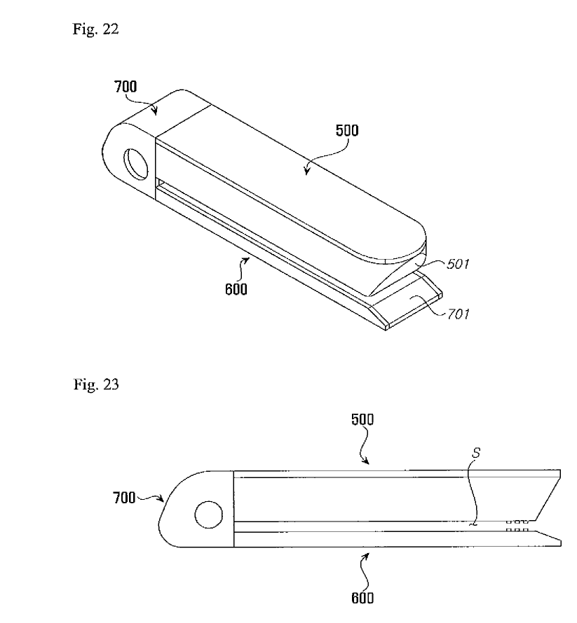

A user inserts a collar into the space S, so that the mobile device can be simply fixed to the collar. In this case, the user may conveniently keep and carry the mobile device, which is in a state of being simply fixed to the collar. In addition, in order for a collar to be easily inserted into the space S of the mobile device, front end surfaces (as viewed in FIG. 22) of the upper and lower units 500 and 600 are formed slantingly.

Specifically, the upper unit 500 has an inclined surface 501 that is inclined outward as it goes from a lower side to an upper side, and the lower unit 600 has an inclined surface 601 that is inclined outward as it goes from an upper side to a lower side.

That is, the inclined surface 501 of the upper unit 500 and the inclined surface 601 of the lower unit 600 are inclined in a direction in which they become more distance from each other as they go from a portion adjacent to the space S toward the outside. Thus, since the space S has a wider entrance, the collar can be easily inserted into the space S.

At this time, the space S has a width corresponding to a width of the mobile device such that the collar can be inserted into the space S and then the mobile device can be fixed to the collar at both sides thereof.

The upper unit 500 includes an upper frame 510 defining an external appearance of the upper unit, a controller 530 received in the upper frame 510, an upper cover 540 coupled to an upper side of the upper frame 510, and a lower cover 550 coupled to a lower side of the upper frame 510.

The lower unit 600 includes a lower frame 610 defining an external appearance of the lower frame, a battery 630 received in the lower frame 610 to supply power, and a battery cover 640 coupled to an upper side of the lower frame 610 in a state where the battery 630 is received in the lower frame 610.

Specifically, a first coupling portion 520 for being coupled to the lower frame 610 is formed to protrude from a rear end of the upper frame 510. An upper surface of the first coupling portion 520 includes a flat surface 521 and a round surface 522 formed to be round downward from the flat surface 521.

Here, the reason why the upper surface of the first coupling portion 520 includes the flat surface 521 and the round surface 522 is because the first coupling portion 520 is prevented from rotating with respect to the cover member 700 in a state where the cover member 700 is coupled to the first coupling portion 520.

Here, although the upper surface of the first coupling portion 520 includes the flat surface 521 and the round surface 522 so as to prevent the rotation of the first coupling portion 520, the spirit of this embodiment is not limited to such a configuration, but various configurations may be applied thereto. For example, it is also possible that a projection is formed on any one of the first coupling portion and an inner circumference of the cover member, and then an insertion recess is formed in the other one so that the projection is inserted in the insertion recess.

In addition, the first coupling portion 520 is formed with a seating portion 523 on which an earphone coupling portion 532 is seated. The seating portion 523 is formed in a lower side of the first coupling portion 520 to be concave upward. Also, a first coupling end 524 is formed to protrude from the first coupling portion 520 to be coupled with the lower frame 610. An anti-sliding portion 560 is also formed to protrude downward on a lower surface of the lower cover 550.

Meanwhile, the lower frame 610 is formed with a battery receiving portion 611 in which the battery 630 is received. In addition, an insertion hole 612 is formed in the front end surface of the lower frame 610 so that the battery 630 is inserted through the insertion hole. Also, the battery 630 slides into the battery receiving portion 611 through the insertion hole 612. In addition, the battery cover 640 is slidably coupled to the lower frame 610.

At this time, since the battery 630 is positioned between the lower frame 610 and the upper unit 500, the battery 630 is preferably received in the lower frame 610 in a sliding manner so that the battery 630 can be smoothly mounted. Due to the same reason, the battery cover 640 is also preferably coupled to the lower frame 610 in a sliding manner.

Although it has been illustrated in this embodiment that the battery 630 is received in an upper side the lower frame 610, on the contrary, the battery may be received in a lower side of the lower frame and the battery cover may be coupled to the lower side of the lower frame. In this case, the battery may not be received in the lower frame in a sliding manner but be received therein in various ways. The battery cover may also be coupled to the lower frame in various ways.

In addition, an anti-sliding portion 650 is formed on an upper surface of the battery cover 640. Thus, since the anti-sliding portions 560 and 650 formed on the lower cover 550 and the battery cover 640 are in close contact with both sides of the collar, the mobile device can be maintained in a fixed state to the collar.

A second coupling portion 620 is formed to protrude from the rear end of the lower frame 610 to be coupled with the first coupling portion 520. Specifically, the second coupling portion 620 has a support surface 622 that extends in a horizontal direction from the rear end of the lower frame 610 to support the earphone coupling portion 532.

In addition, a vertical rib 624 is formed on the support surface 622 so as to space apart the upper unit 500 and the lower unit 600 from each other by a predetermined distance. Thus, in a state where the coupling portion 520 is coupled with the second coupling portion 620, the upper unit 500 and the lower unit 600 are spaced apart by the vertical rib 624, thereby defining the space S between the upper unit 500 and the lower unit 600.

Also, a pair of second coupling ends 625 and 626 coupled with the first coupling end 524 are formed to protrude upward from the support surface 622. The second coupling ends 625 and 626 are spaced apart from each other by an interval as much as a thickness of the first coupling end 524. In addition, when the first coupling portion 520 is coupled with the second coupling portion 620, the first coupling end 524 is inserted into a space between the pair of second coupling ends 625 and 626.

Meanwhile, the cover member 700 cover the coupling portions 520 and 620 together in a state where they are coupled with each other.

In addition, the upper surface of the cover member 700 is formed in the shape corresponding to the upper surface of the first coupling portion 520. That is, the upper surface of the cover member 700 includes a flat surface 711 and a round surface 712 that is formed to be round downward from the flat surface 711.

Also, a through hole 713 is formed in one side surface of the cover member 700 so that an earphone jack may pass through the hole. In addition, a coupling hole 714 is formed in the other side surface of the cover member 700 so that a first coupling member 720 is coupled. Also, the first coupling member 720 passing through the coupling hole 714 is coupled to the first coupling end 524 and the pair of second coupling ends 625 and 626 at the same time.

Thus, coupling holes 525 and 627 are respectively formed in the first coupling end 524 and the second coupling ends 625 and 626 so that the first coupling member 720 is coupled thereto.

In addition, a plurality of coupling holes 623 are formed in a lower surface of the cover member 700 so that a plurality of second coupling members 730 may be coupled thereto. Also, the second coupling members 730 passing through the coupling holes 623 are coupled to the support surface 622. Thus, the plurality of coupling holes 623 to which the second coupling members 730 coupled are formed in the support surface 622.

Hereinafter, a coupling process of the mobile device will be described.

First, each of the upper unit 500 and the lower unit 600 is completely assembled. Specifically, in a state where the controller 530 is received in the upper frame 510, the upper cover 540 and the lower cover 550 are coupled to the upper and lower sides of the upper frame 510.

At this time, the earphone coupling portion 532 may be fixed to the controller 530. If the controller 530 is received in the upper frame 510, the earphone coupling portion 532 is seated on the seating portion 523, and is exposed to the outside of the upper frame 510 in a state where the lower cover 550 is coupled with the lower frame 610.

Meanwhile, after the battery 630 is received in the lower frame 610, the battery cover 640 is coupled to the upper side of the lower frame 610.

Then, the first coupling portion 520 of the upper frame 510 is coupled to the second coupling portion 620 of the lower frame 610. If the first and second coupling portions 520 and 620 are coupled, the first coupling end 524 is positioned between the second ends 625 and 626, and the coupling hole 525 of the first coupling end 524 is aligned with the coupling holes 627 of the second coupling ends 625 and 626.

In addition, in a state where the first coupling portion 520 is coupled with the second coupling portion 620, the outside of the coupling portions 520 and 620 is covered with the cover member 700.

Also, in a state where the cover member 700 is coupled to the coupling portions 520 and 620, the first coupling member 720 is coupled to the side surface of the cover member 700, and the second coupling members 730 are coupled to the lower surface of the cover member 700.

According to the present invention, a speaker is rotatably installed to a main body of a mobile device, so that the speaker can be seated in the main body when a user does not operate the speaker. Thus, there is an advantage in that the mobile device has a better design for an external appearance.

In addition, it is possible in the present invention to stand the mobile device using a speaker or a support plate. Therefore, there is an advantage in that convenience of a user is enhanced.

Further, according to the present invention, the main body can be caught to a collar of a user or a hook. Thus, there is an effect in that the user can easily carry the mobile device.

The scope of the present invention is not limited to the embodiments described above but is defined by the appended claims. It will be apparent that those skilled in the art can make various modifications and changes thereto within the scope of the invention defined by the claims.

What is claimed is:

1. A mobile device, comprising:
a main body having a display provided on a surface thereof, and
at least one speaker pivotably connected to one side of the main body so that the main body is selectively supported on the ground stably through the speaker, the speaker receiving a signal from the main body and forming a sonic wave to generate a sound.

2. The mobile device as claimed in claim 1, wherein the main body includes a speaker seating portion concavely formed in a lower end of a rear surface of the main body, the speaker comprising a pair of speakers respectively hinged to both side ends of the main body, and the speakers being configured to pivot on the rear surface of the main body to protrude therefrom to support the main body on the ground.

3. The mobile device as claimed in claim 2, wherein the speaker includes a support surface formed on a lower end of the speaker to be in contact with the ground, and the support surface is formed slantingly so that the main body is inclined at a predetermined slope with respect to the ground through the support surface.

4. The mobile device as claimed in claim 1, wherein the speaker is pivotably connected to the main body so that the speaker is folded on or unfolded with respect to the display of the main body.

5. The mobile device as claimed in claim 4, further comprising a hinge for connecting the speaker with the main body, wherein the hinge has both ends hinged through binge shafts to hinge seating portions formed in one side ends of the speaker and the main body, respectively, each of the speaker and the main body being pivotable more than 180 degrees about each hinge shaft.

6. The mobile device as claimed in claim 5, wherein engagement protrusions are elastically supported on inner side surfaces of both ends of the hinge seating portion so that the engagement protrusions protrude, and concavo-convex portions are formed in both the ends of the hinge so that the engagement protrusions are engaged with the concavo-convex portions, respectively, thereby allowing the speaker and the main body to be pivotable within a predetermined angle.

7. The mobile device as claimed in claim 5, wherein the main body and the speaker have substantially same size, so that the main body is substantially aligned with the speaker when the mobile device is folded through an operation of the binge.

8. A portable digital device, comprising:
a main body having a seating portion stepped on a rear surface thereof; and
at least one speaker rotatably installed to the main body to be selectively positioned in the seating portion or a front surface of the main body, the speaker having a speaker grille formed on one surface thereof so that the speaker faces the seating portion in a state where the speaker is seated on the seating portion.

9. The portable digital device as claimed in claim 8, wherein the main body includes a support for selectively supporting the main body, the support being rotatably provided in the seating portion of the rear surface of the main body.

10. The portable digital device as claimed in claim 9, wherein the main body and the speaker include protrusions that are respectively formed in the main body and the speaker at corresponding positions thereof and connectors for connecting the protrusions are rotatably provided at both side surfaces of the protrusions.

11. The portable digital device as claimed in claim 10, wherein contacts for electrically connecting the speaker to an inside of the main body are formed on corresponding surfaces of the protrusions and connectors that are in contact with each other.

12. The portable digital device as claimed in claim 9, wherein a support seating recess, in which the support is selectively seated, is concavely formed in the rear surface of the main body having the seating portion formed therein.

13. The portable digital device as claimed in claim 12, wherein the support includes an extension slidable into or out of the support to selectively extend a length of the support.

14. A mobile device, comprising:
a main body having one or more insertion portions concavely formed in one surface thereof; and
a support plate partially inserted into one of the one or more insertion portions to support the main body on the ground.

15. The mobile device as claimed in claim 14, wherein inner surfaces of the insertion portions have different tilt angles.

16. The mobile device as claimed in claim 15, wherein the insertion portion has a first seating groove into which a relatively longer side of the support plate is inserted, and a second seating groove formed from the first seating groove more concavely by a predetermined depth toward the inside of the main body, the second seating groove having a relatively shorter length than the first seating groove so that a relatively shorter side of the support plate is inserted therein.

17. The mobile device as claimed in claim 14, further comprising a cover made of a rubber material and having a shape corresponding to the insertion portion, which is provided in the insertion portion.

18. A mobile device, comprising:
a main body; and
a hanger rotatably coupled to an outside surface of the main body and having a catching portion provided in one side thereof, the hanger being configured to catch an external article.

19. The mobile device as claimed in claim 18, wherein the main body includes a coupling portion to which the hanger is slidably coupled.

20. The mobile device as claimed in claim 18, further comprising an elastic member having one side coupled to the hanger and the other side coupled to the main body, the elastic member providing elastic force in a direction in which the hanger is brought into contact with the main body.

21. The mobile device as claimed in claim 20, wherein the hanger comprises a pair of bodies, the bodies being provided in both ends of the catching portion and coupled to both side surfaces of the coupling portion, and wherein the bodies are respectively formed with coupling units to be coupled with the coupling portion, and a plurality of coupling holes are formed in both the side surfaces of the coupling portion so that the coupling units are coupled to the coupling holes.

22. The mobile device as claimed in claim 18, wherein the main body includes a battery for supplying power and a battery cover selectively coupled to the main body to cover the battery, and the hanger is positioned on a moving path of the battery cover in a process of separating the battery cover from the main body.

23. A mobile device, comprising:
a main body;
an upper unit configured to define an upper external appearance of the mobile device; and
a lower unit coupled with the upper unit to define a lower external appearance of the mobile device, wherein one surface of the lower unit facing the upper unit is coupled to the upper unit to be spaced apart from the upper unit, and the main body is provided within the upper or lower unit.

24. The mobile device as claimed in claim 23, wherein coupling portions are respectively provided in the upper and lower units to couple them, and a cover member is coupled to the coupling portions to cover the coupling portions in a state where the coupling portions are coupled.

25. The mobile device as claimed in claim 23, wherein the upper and lower units include anti-sliding units formed on surfaces of the upper and lower units, the surfaces facing each other.

26. The mobile device as claimed in claim 23, wherein the upper unit has an inclined surface inclined outwardly from a lower side to an upper side of the upper unit, and the lower unit has an inclined surface inclined outwardly from an upper side to a lower side of the lower unit.
